(19) United States
(12) Patent Application Publication
(10) Pub. No.: US 2025/0196886 A1
(43) Pub. Date: Jun. 19, 2025

(54) PATH PLANNING AND OPERATION DOMAIN NAVIGATION WITH GNSS ERROR PREDICTIONS

(71) Applicant: Ford Global Technologies, LLC, Dearborn, MI (US)

(72) Inventors: Sharnam Shah, San Francisco, CA (US); Ganesh Kumar, Santa Clara, CA (US); Nalin Bendapudi, Ann Arbor, MI (US); Md Nahid Pervez, San Jose, CA (US); Ankit Girish Vora, Northville, MI (US)

(73) Assignee: Ford Global Technologies, LLC, Dearborn, MI (US)

(21) Appl. No.: 18/543,224

(22) Filed: Dec. 18, 2023

(51) Int. Cl. B60W 60/00; B60W 40/105; B60W 50/00; G01S 19/42

(52) U.S. Cl. CPC B60W 60/0011; B60W 40/105; B60W 50/0097; G01S 19/42; B60W 2050/0022; B60W 2556/10; B60W 2556/50

(57) ABSTRACT

A computer that includes a processor and a memory, the memory including instructions executable by the processor to receive Global Navigation Satellite System (GNSS) error predictions corresponding to respective potential paths between a vehicle location and a specified destination. The memory includes instructions to identify a lowest-cost path from the potential paths based on path costs determined based on the respective GNSS error predictions for the potential paths. A propulsion subsystem and a steering subsystem of the vehicle are controlled to operate the vehicle along the lowest-cost path.

### BACKGROUND

Computers can be used to operate systems including vehicles, robots, drones, and/or object tracking systems. Data can be acquired by sensors and processed using a computer to determine a location of a system with respect to objects in an environment around the system. The computer may use the location to determine trajectories for moving a system in the environment. The computer may then determine control data to transmit to system components to control system components to move the components according to the determined trajectories.

### BRIEF DESCRIPTION OF THE DRAWINGS

FIG. 1 is a block diagram of an example vehicle sensing system.

FIG. 2 is a diagram of an example map with multiple potential paths between a vehicle location and a specified destination.

FIG. 3 is a diagram of an example potential path between a vehicle location and a specified destination including segments.

FIG. 4 is a block diagram of an example path planning system using a GNSS error-based cost function.

FIG. 5 is a flowchart diagram of an example process to identify a lowest-cost path based on GNSS error predictions.

### DETAILED DESCRIPTION

Robots and/or vehicles can use the GNSS (Global Navigation Satellite System) as an input for navigation, path-planning, and determining which if any computer-controlled vehicle operations, such as advanced driver assistance system (ADAS) features, are available. Systems including vehicles, robots, drones, etc., can be operated by acquiring sensor data, including GNSS data, regarding an environment around the system and processing the sensor data to determine a path upon which to operate the system or portions of the system. Sensor data can be processed to determine a pose for the system, where a “pose” specifies a location and an orientation of an object such as a system and/or components thereof. A system pose can be determined based on a six degree-of-freedom (DoF) pose which includes x, y, and z location coordinates, and roll, pitch, and yaw rotational coordinates with respect to the x, y, and z axes, respectively. The six DoF pose can be determined with respect to a global coordinate system such as a Cartesian coordinate system in which points can be specified according to latitude, longitude, and altitude or some other x, y, and z axes.

GNSS data can generally provide pose resolution ranging from less than 0.3 meters to over 3.0 meters. The availability of ADAS features depends on the available pose resolution. ADAS including various driver assist technology (DAT) are computer-implemented or controlled features that assist in vehicle driving and parking operations. Examples of ADAS include forward proximity detection, lane-departure detection, blind-spot detection, braking actuation, adaptive cruise control, lane-keeping assistance, speed control, and/or steering control. With better pose resolution it may be possible to provide additional and/or enhanced ADAS features.

Techniques described herein take into account GNSS error predictions to select a path, from alternative potential paths, which has the lowest overall GNSS errors, thereby maximizing the availability of computer-controlled vehicle operations. A cost function is used to calculate a cost for each potential path based on the corresponding GNSS error predictions and select the potential path with the lowest cost.

Disclosed herein is a system including a computer that includes a processor and a memory. The memory includes instructions executable by the processor to receive GNSS error predictions corresponding to respective potential paths between a vehicle location and a specified destination. The instructions can include identifying a lowest-cost path from the potential paths based on path costs determined based on the respective GNSS error predictions for the potential paths and controls a propulsion subsystem and/or a steering subsystem of the vehicle to operate the vehicle along the lowest-cost path.

The instructions to calculate the path costs can include instructions to calculate an operating domain cost, a functionality cost, and a margin cost. The instructions can also include summing at least the calculated operating domain cost, the calculated functionality cost, and the calculated margin cost.

The instructions to calculate the operating domain cost can include instructions to divide the potential path into multiple segments and multiply the distance of each segment by a domain weight and a GNSS error prediction corresponding to the segment to determine an operating weighted distance. The instructions can also include summing the operating weighted distances of the multiple segments.

The instructions to calculate the functionality cost can include instructions to divide the potential path into multiple segments and determine for each segment which of multiple predetermined ranges the GNSS error prediction corresponding to the segment is located. The distance of each segment is multiplied by a weighting factor corresponding to the determined range to calculate a functionality weighted distance and the functionality weighted distances of the multiple segments is summed.

The instructions to calculate the margin cost can include instructions to divide the potential path into multiple segments and multiply the distance of each segment by a margin factor calculated based on a GNSS error prediction corresponding to the segment to determine a margin weighted distance. The instructions also include summing the margin weighted distances of the multiple segments.

The instructions to calculate the margin factor can include instructions to calculate a probability that a GNSS error distance will exceed a selected distance threshold based on the GNSS error prediction, divide the probability by a desired probability to determine a probability weight, and exponentiate the probability weight to a selected power.

The instructions to calculate the probability can include instructions to integrate a normal distribution function using the GNSS error prediction as a standard deviation.

The instructions to calculate the functionality cost and the margin cost can include instructions to divide the potential path into multiple segments. The instructions include determining for each segment which of multiple predetermined ranges the GNSS error prediction corresponding to the segment is located and multiply the distance of each segment by a weighting factor corresponding to the determined range to determine a functionality weighted distance. The instructions also include multiplying the distance of each segment by a margin factor calculated based on a GNSS error prediction corresponding to the segment to determine a margin weighted distance and summing the functionality weighted distances and the margin weighted distances of the multiple segments.

The instructions to calculate the path costs can include instructions to calculate the cost based on at least a potential path distance and a vehicle speed. The instructions can further include instructions to determine the GNSS error predictions based on historical data for particular locations and times.

Disclosed herein is a method for vehicle navigation path planning including receiving GNSS error predictions corresponding to respective potential paths between a vehicle location and a specified destination. The method includes identifying a lowest-cost path from the potential paths based on path costs determined based on the respective GNSS error predictions for the potential paths and controlling a propulsion subsystem and/or a steering subsystem of the vehicle to operate the vehicle along the lowest-cost path.

Calculating the path costs can include calculating an operating domain cost, a functionality cost, and a margin cost and summing at least the calculated operating domain cost, the calculated functionality cost, and the calculated margin cost.

Calculating the operating domain cost can include dividing the potential path into multiple segments and multiplying the distance of each segment by a domain weight and a GNSS error prediction corresponding to the segment to determine an operating weighted distance. The method can include summing the operating weighted distances of the multiple segments.

Calculating the functionality cost can include dividing the potential path into multiple segments. The method can include determining for each segment which of multiple predetermined ranges the GNSS error prediction corresponding to the segment is located and multiplying the distance of each segment by a weighting factor corresponding to the determined range to calculate a functionality weighted distance. The method can include summing the functionality weighted distances of the multiple segments.

Calculating the margin cost can include dividing the potential path into multiple segments and multiplying the distance of each segment by a margin factor calculated based on a GNSS error prediction corresponding to the segment to determine a margin weighted distance. The method can include summing the margin weighted distances of the multiple segments.

Calculating the margin factor can include calculating a probability that a GNSS error distance will exceed a selected distance threshold based on the GNSS error prediction, dividing the probability by a desired probability to determine a probability weight, and exponentiating the probability weight to a selected power.

Calculating the probability can include integrating a normal distribution function using the GNSS error prediction as a standard deviation.

Calculating the functionality cost and the margin cost can include dividing the potential path into multiple segments. The method can also include determining for each segment which of multiple predetermined ranges the GNSS error prediction corresponding to the segment is located and multiplying the distance of each segment by a weighting factor corresponding to the determined range to determine a functionality weighted distance. The distance of each segment can be multiplied by a margin factor calculated based on a GNSS error prediction corresponding to the segment to determine a margin weighted distance. The method can include summing the functionality weighted distances and the margin weighted distances of the multiple segments.

Calculating the path costs can include calculating the cost based on at least a potential path distance and a vehicle speed. The method can further include determining the GNSS error predictions based on historical data for particular locations and times.

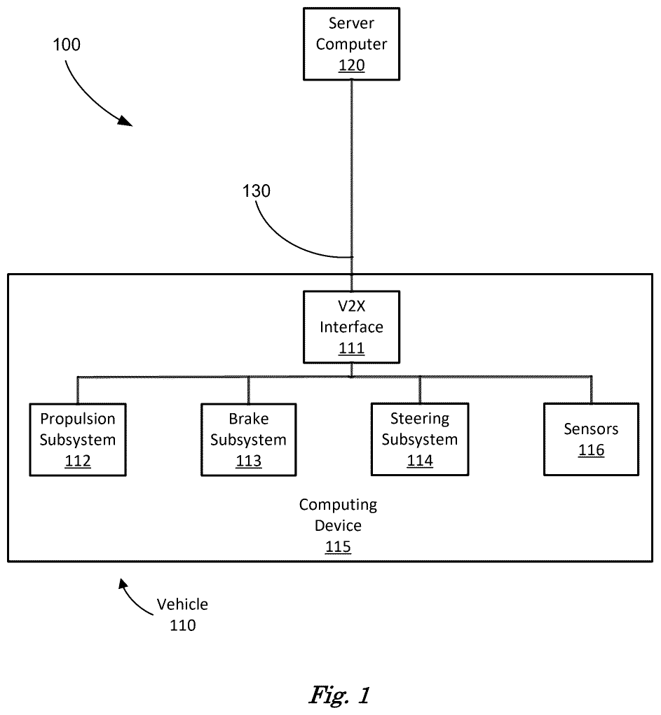

FIG. 1 is a diagram of an example system 100. The system 100 includes a vehicle 110, operable by a user and/or according to control by a computing device or devices 115 which can include one or more vehicle electronic control units (ECUs) or computers, such as are known, possibly including additional hardware, software, and/or programming as described herein. A computing device 115 can receive data regarding the operation of the vehicle 110 from sensors 116. A computing device 115 may operate the vehicle 110 or components thereof instead of or in conjunction with control by a human user. The system 100 can further include a remote (i.e., external to the vehicle) server computer 120 that can communicate with the vehicle 110 via a network 130.

The computing device 115 can include one or more processors and one or more memory devices such as are known. Further, the memory includes one or more forms of computer-readable media, and stores instructions executable by the processor for performing various operations, including as disclosed herein. For example, the computing device 115 may include programming to operate one or more of vehicle brakes, propulsion (e.g., control of acceleration in the vehicle 110 by controlling one or more of an internal combustion engine, electric motor, hybrid engine, etc.), steering, climate control, interior and/or exterior lights, etc., as well as to determine whether and when the computing device 115, as opposed to a human operator, is to control such operations.

The computing device 115 may include or be communicatively coupled to, e.g., via a vehicle communications bus as described further below, more than one computing device, e.g., controllers, ECUs, or the like included in the vehicle 110 for monitoring and/or controlling various vehicle subsystems, e.g., a propulsion subsystem 112, a brake subsystem 113, a steering subsystem 114, etc. The computing device 115 is generally arranged for communications on a vehicle communication network, e.g., including a bus in the vehicle 110 such as a controller area network (CAN) or the like. The vehicle network can additionally or alternatively include wired or wireless communication mechanisms such as are known, e.g., Ethernet or other communication protocols.

Via the vehicle network, the computing device 115 may transmit messages to various devices in the vehicle and/or receive messages from the various devices, e.g., controllers, actuators, sensors, etc., including sensors 116. Alternatively, or additionally, in cases where the computing device 115 actually comprises multiple devices, the vehicle communication network may be used for communications between devices represented as the computing device 115 in this disclosure. Further, as mentioned below, various controllers or sensing elements such as sensors 116 may provide data to the computing device 115 via the vehicle communication network.

In addition, the computing device 115 may be configured for communicating through a vehicle-to-infrastructure (V-to-I) interface with a remote server computer 120, e.g., a cloud server, via a network 130, which, as described below, includes hardware, firmware, and software that permits computing device 115 to communicate with a remote server computer 120 via a network 130 such as wireless Internet (WI-FI®) or cellular networks. V2X interface 111 may accordingly include processors, memory, transceivers, etc., configured to utilize various wired and/or wireless networking technologies, e.g., cellular, BLUETOOTH®, Bluetooth Low Energy (BLE), Ultra-Wideband (UWB), Peer-to-Peer communication, UWB based Radar, IEEE 802.11, and/or other wired and/or wireless packet networks or technologies. Computing device 115 may be configured for communicating with other vehicles through V2X (vehicle-to-everything) interface 111 using vehicle-to-vehicle (V-to-V) networks, e.g., according to including cellular communications (C-V2X) wireless communications cellular, Dedicated Short Range Communications (DSRC) and/or the like, e.g., formed on an ad hoc basis among nearby vehicles 110 or formed through infrastructure-based networks. The computing device 115 also includes nonvolatile memory such as is known. Computing device 115 can log data by storing the data in nonvolatile memory for later retrieval and transmittal via the vehicle communication network and a vehicle to infrastructure (V2X) interface 111 to a server computer 120 or user mobile device.

As already mentioned, generally included in instructions stored in the memory and executable by the processor of the computing device 115 is programming for operating one or more vehicle 110 components, e.g., braking, steering, propulsion, etc. Using data received in the computing device 115, e.g., the sensor data from the sensors 116, the server computer 120, etc., the computing device 115 may make various determinations and/or control various vehicle 110 components and/or operations. For example, the computing device 115 may include programming to control vehicle 110 operational behaviors (e.g., physical manifestations of vehicle 110 operation) such as speed, acceleration, deceleration, steering, etc., as well as tactical behaviors (e.g., control of operational behaviors typically in a manner intended to achieve efficient traversal of a route) such as a distance between vehicles and/or amount of time between vehicles, lane-change, minimum gap between vehicles, left-turn-across-path minimum, time-to-arrival at a particular location and intersection (without signal) minimum time-to-arrival to cross the intersection.

Each of the subsystems 112, 113, 114 may include respective processors and memories and/or one or more actuators. The subsystems 112, 113, 114 may be programmed and connected to a vehicle 110 communications bus, such as a controller area network (CAN) bus or local interconnect network (LIN) bus, to receive instructions from the computing device 115 and control actuators based on the instructions.

Sensors 116 may include a variety of devices such as are known to provide data via the vehicle communications bus. For example, a radar fixed to a front bumper (not shown) of the vehicle 110 may provide a distance from the vehicle 110 to a next vehicle in front of the vehicle 110, or a GNSS sensor disposed in the vehicle 110 may provide geographical coordinates of the vehicle 110. The distance(s) provided by the radar and/or other sensors 116 and/or the geographical coordinates provided by the GNSS sensor may be used by the computing device 115 to operate the vehicle 110.

The vehicle 110 is generally a land-based vehicle 110 having three or more wheels, e.g., a passenger car, light truck, etc. The vehicle 110 includes one or more sensors 116, the V2X interface 111, the computing device 115 and one or more subsystems 112, 113, 114. The sensors 116 may collect data related to the vehicle 110 and the environment in which the vehicle 110 is operating. By way of example, and not limitation, sensors 116 may include, e.g., altimeters, cameras, LIDAR, radar, ultrasonic sensors, infrared sensors, pressure sensors, accelerometers, gyroscopes, temperature sensors, pressure sensors, hall sensors, optical sensors, voltage sensors, current sensors, mechanical sensors such as switches, etc. The sensors 116 may be used to sense the environment in which the vehicle 110 is operating, e.g., sensors 116 can detect phenomena such as weather conditions (precipitation, external ambient temperature, etc.), the grade of a road, the location of a road (e.g., using road edges, lane markings, etc.), or locations of target objects such as neighboring vehicles. The sensors 116 may further be used to collect data including dynamic vehicle data related to operations of the vehicle 110 such as velocity, yaw rate, steering angle, engine speed, brake pressure, oil pressure, the power level applied to subsystems 112, 113, 114 in the vehicle 110, connectivity between components, and accurate and timely performance of components of the vehicle 110.

Server computer 120 typically has features in common, e.g., a computer processor and memory and configuration for communication via a network 130, with the vehicle 110 V2X interface 111 and computing device 115, and therefore these features will not be described further. A server computer 120 can be used to develop and train software that can be transmitted to a computing device 115 in a vehicle 110.

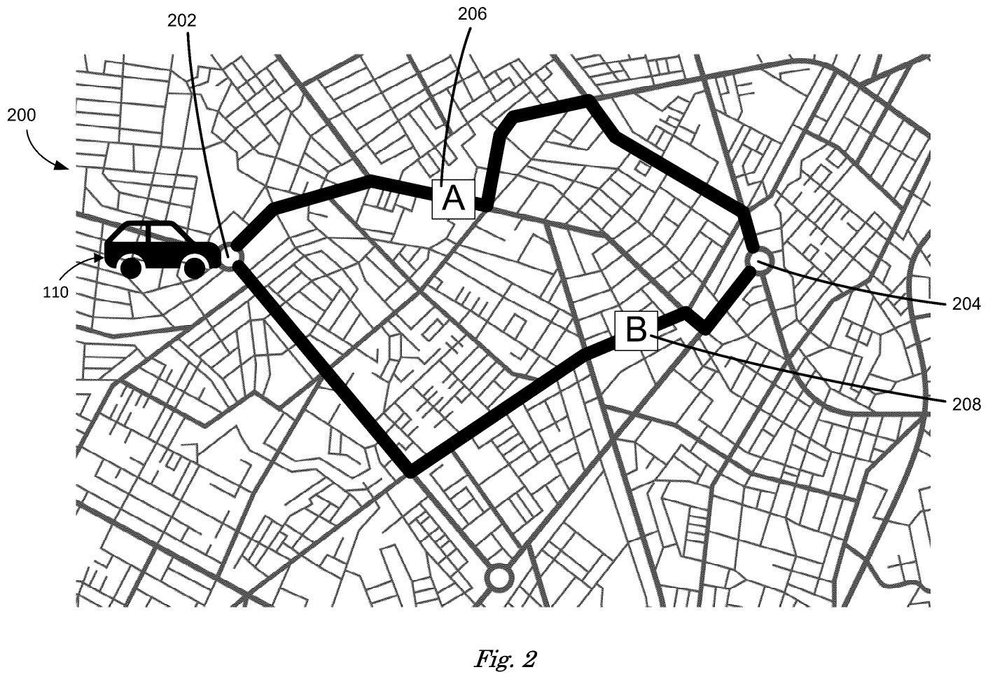

FIG. 2 is a diagram of a map 200 illustrating multiple potential paths 206 and 208 between a vehicle 110 location 202 and a selected destination 204. In an example, the map 200 can be a map downloaded to a computing device 115 in the vehicle 110 via the network 130, e.g., from a source such as GOOGLE™ maps. The computer 115 can use any suitable algorithm for global motion planning to select the potential paths, e.g., incremental-search based planners such as rapidly-exploring random tree (RRT), graph-based planning methods that use road structures, sampling-based methods such as probabilistic roadmap path (PRM) planning, etc. While two potential paths are shown in the depicted example, many additional potential paths can be determined for evaluation using the disclosed technology.

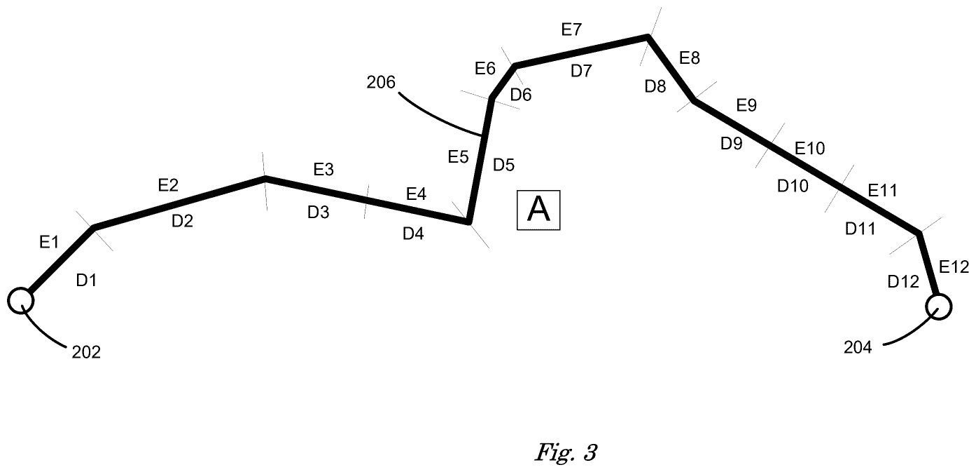

With reference to FIG. 3, each potential path, e.g., path 206, can be segmented as part of the lowest-cost analysis. The paths can be segmented based on a distance threshold of 100-200 meters, for example. The threshold distance can be reduced or increased depending on road characteristics, such as curvature. If the path includes a curve, the segment distance can be shortened for the curved portion of the path. Straight flat sections along the path can have increased segment lengths. In addition, the paths can be segmented at each intersection. In some examples, the segments can include multiple lanes. Each segment lane can be evaluated separately to facilitate lane level path planning. Each segment 1-12 has a corresponding distance D1-D12 and a corresponding GNSS error prediction E1-E12. Each lane within a segment can have a corresponding lane level GNSS error prediction. The distances D1-D12 can be in meters and the GNSS error predictions E1-E12 can be in meters or provided as a standard deviation value σ. In an example, the GNSS error predictions can be an average error value for the corresponding segment.

The GNSS error predictions can be based on historical crowd-sourced GNSS error data from vehicles that have traveled in an area of interest. The GNSS error can be determined by comparing real-time kinematic positioning (RTK) with GNSS information. RTK takes in the normal signals from the GNSS along with a correction stream to determine location with e.g., 1 centimeter (cm) positional accuracy. As vehicles with RTK combined with GNSS capabilities travel around on various roads the determined GNSS errors can be continuously stored to the cloud as a GNSS error map with the errors stored relative to location and time, for example.

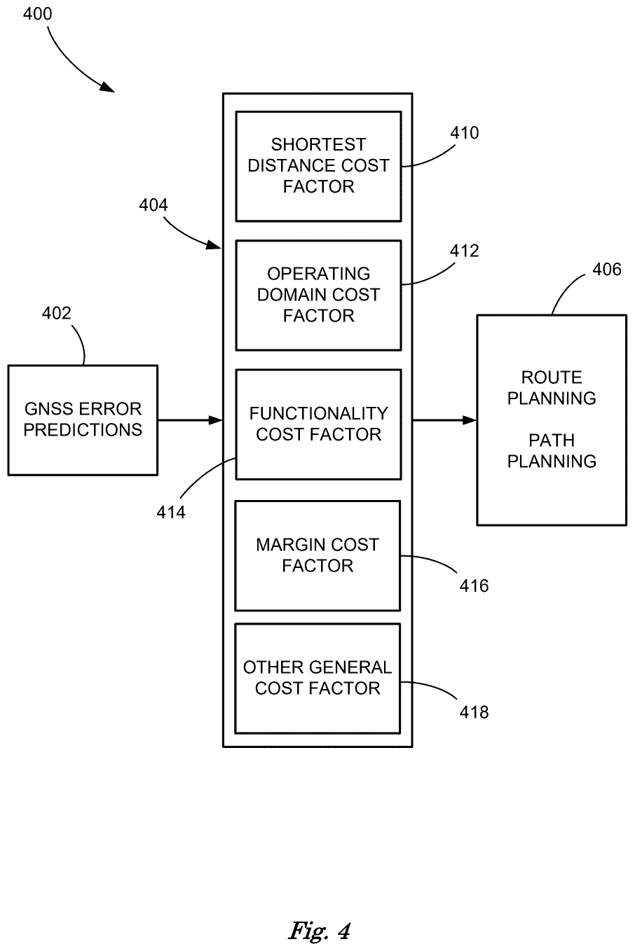

FIG. 4 is a block diagram of an example path planning system 400 using a GNSS error-based cost function 404. The GNSS error-based cost function 404 receives GNSS error predictions 402 and provides a cost per path to a conventional route planning and path planning system 406. For example, the planning system 406 can select the potential path with the lowest cost and/or incorporate the path costs into additional evaluation and planning layers. For example, a lane level layer can plan a path from A to B on a discrete (lane node-level) representation of the map. A behavior layer can contain tactical logic to make decisions such as lane-changes, overtakes, merges, intersection-handling etc. A trajectory generator layer can generate a trajectory from the selected path, which can include position, orientation, velocity, angular velocity, and acceleration with respect to time. A motion control layer can calculate brake, throttle, and steer commands according to the provided trajectory.

The GNSS error-based cost function 404 includes a shortest distance cost factor 410, an operating domain cost factor 412, a functionality cost factor 414, a margin cost factor 416, and a general cost factor 418. The shortest distance cost factor 410 is the distance of each segment. The other general cost factors 418 can include conventional factors, such as speed, travel time, minimizing traffic lights, etc. The cost per path can be calculated by summing these factors for each potential path according to Equation 1.

$$Cost per path = ( path distance ) + ( GNSS error operating domain cost ) + ( GNSS error functionality cost and margin cost ) + ( other general cost factors ) \qquad ( 1 )$$

The GNSS error for operating domain cost factor 412 can be calculated for each potential path by multiplying the distance of each segment by a domain weight and a GNSS error prediction corresponding to the segment to determine an operating weighted distance and summing the operating weighted distances of the multiple segments according to Equation 2. In an example, if the GNSS error for a segment exceeds a threshold, e.g., 7 meters, the domain weight is set at a number greater than 1, e.g., 3; otherwise, the domain weight can be set at 1. The threshold can be selected based on the resolution necessary for computer-controlled vehicle operations. The domain weight can be selected empirically based on the importance of having computer-controlled vehicle operations available.

$$GNSS error for operating domain cost = \sum ( segment distance * corresponding segment error * domain weight ) \qquad ( 2 )$$

The GNSS error functionality cost factor 414 can be calculated by determining, for each segment, which of multiple predetermined ranges the GNSS error prediction corresponding to the segment is located and multiplying the distance of each segment by a weighting factor corresponding to the determined range to calculate a functionality weighted distance. For example, if the GNSS error prediction for a given segment is between 0.3 meters and 1.5 meters, the weighting factor is set at 1; if the GNSS error prediction for the segment is greater than one meter, the weighting factor is set at 3; if the GNSS error prediction for the segment is greater than five meters, the weighting factor is set at 10. The ranges can be selected based on the necessary resolution for different e.g., ADAS features, and the weighting factors can be determined empirically, for example. The GNSS error functionality cost per path can be calculated by summing the functionality weighted distances for the segments according to Equation 3.

$$GNSS error functionality cost = \sum ( segment distance * weight ) \qquad ( 3 )$$

The GNSS error ranges, or ranges like the GNSS error ranges, can also be used to determine localization levels for e.g., ADAS functionality. For example, errors less than 0.3 meters can enable “within lane” localization features; errors between 0.3-1.5 meters can enable “which lane” localization features; and errors between 1.5-5 meters can enable “which road” localization level features. As an example, if “within lane” localization features are available, the system may be allowed to perform more computer-controlled vehicle operations as compared to e.g., road level localization where features like lane changes or lane determination are not allowed.

The GNSS error margin cost factor 418 can be calculated by multiplying the distance of each segment by a margin factor calculated based on a GNSS error prediction corresponding to the segment to determine a margin weighted distance and summing the margin weighted distances of the multiple segments according to Equation 4.

$$GNSS error margin cost = \sum ( segment distance * margin factor ) \qquad ( 4 )$$

Calculating the margin factor (Equation 5) can include calculating a probability f(x) that a GNSS error distance will exceed a selected distance threshold x based on the GNSS error prediction σ and dividing the probability f(x) by a desired probability to determine a probability weight. The desired probability can be a level of confidence that the GNSS error distance will fall below an operating limit corresponding to a point below which vehicle operations can be controlled by a computer. The probability weight can be exponentiated to a selected scaling factor power (e.g., ⅓ or ¼) in order to adjust the significance that the GNSS error margin cost has in the overall cost function.

$$Margin Factor = {( Probability / Desired Probability )}^{Scaling Factor} \qquad ( 5 )$$

In an example, the desired probability can be 10⁻⁸ which is an occurrence rate of e.g., 1 occurrence in 10⁸. This corresponds to 5.73σ. The selected distance threshold x can be an operating limit, e.g., 0.57 meters. An occurrence of an error distance above this operating limit may be considered too large for certain functionality. This translates to 5.73σ=0.57, hence σ covariance=0.57/5.73=0.0994.

Calculating the probability can include integrating a normal distribution function (Equation 6) using the GNSS error prediction corresponding to a segment as the standard deviation σ, where x=the selected distance threshold of 0.57 meters, and the mean μ=0, assuming a normal distribution.

$$f ( x ) = \frac{1}{σ \sqrt{2 π}} {e}^{- \frac{1}{2} {( \frac{x - μ}{σ} )}^{2}} \qquad ( 6 )$$

In an example, the GNSS error prediction for an example segment (e.g., D3) can be σ=0.2. The probability that the GNSS error is outside the 0.57 meter threshold when the segment GNSS error prediction is σ=0.2 is 0.0022. Thus, the margin factor D3:

$$Margin Factor D 3 = {( 0.0022 / {10}^{- 8} )}^{\frac{1}{3}} = 60.37$$

The margin factor can also be calculated when the error is directly measured, and no covariance is available using Equation 7. The same distribution can be used to find the probability at x=measured error.

$$Margin Factor = {( Desired probability / Probability at Measured x )}^{Scaling Factor} \qquad ( 7 )$$

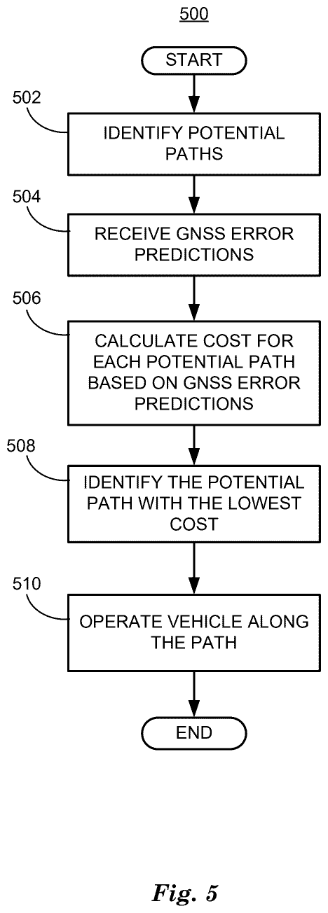

FIG. 5 is a flowchart, described in relation to FIGS. 1-4, of a process 500 for vehicle navigation path planning using GNSS error predictions. Process 500 can be implemented in a computing device 115 included in a vehicle 110. Process 500 includes multiple blocks that can be executed in the illustrated order. Process 500 could alternatively or additionally include fewer blocks or include the blocks executed in different orders.

Process 500 begins at block 502 where a computing device 115 in a vehicle 110 identifies multiple potential paths between a vehicle location and a selected destination. In an example, the computer 115 can use any suitable algorithm for global motion planning to select the potential paths, e.g., incremental-search based planners such as rapidly-exploring random tree (RRT), graph-based planning methods that use road structures, sampling-based methods such as probabilistic roadmap path (PRM) planning, etc. As an example, the potential paths can be in the form of a map, e.g., map 200 downloaded to the computing device 115 via the network 130, e.g., from a source such as GOOGLE maps.

At block 504 computing device 115 receives GNSS error predictions corresponding to respective potential paths between a vehicle location and a specified destination. The GNSS error predictions can be for locations and times corresponding to each potential path. The GNSS error predictions can be provided as a GNSS error map with the errors stored relative to location and time, for example. Thus, the GNSS error predictions can be the GNSS error from the map at the corresponding location and a similar time of day, for example. The GNSS error map can be based on historical GNSS error data gathered from vehicles that have traveled in the same area and/or along the same path or portions of the path. The GNSS error can be determined by comparing RTK positioning with GNSS.

At block 506 computing device 115 calculates a cost for each potential path based on the corresponding GNSS error predictions. The GNSS error-based cost function 404 includes a shortest distance cost factor 410, an operating domain cost factor 412, a functionality cost factor 414, a margin cost factor 416, and a general cost factor 418. The cost per path can be calculated by summing these factors for each potential path.

At block 508 computing device 115 identifies a lowest-cost path from the potential paths based on path costs determined based on the respective GNSS error predictions for the potential paths as in block 506. The lowest-cost path also has the lowest overall GNSS errors, thereby maximizing the availability of computer-controlled vehicle operations.

At block 510 computing device 115 controls the propulsion subsystem 112 and the steering subsystem 114 of the vehicle to operate the vehicle along the lowest-cost path. The computing device 115 determines commands to direct the vehicle's propulsion (e.g., powertrain), braking, and steering components to operate the vehicle so as to travel along the path. A vehicle path can be described by a polynomial function upon which a vehicle, such as vehicle 110, can be operated. Sometimes referred to as a path polynomial, the polynomial function can specify a vehicle location (e.g., according to x, y, and z coordinates) and/or pose (e.g., roll, pitch, and yaw), over time. That is, the path polynomial can be a polynomial function of degree three or less that describes the motion of a vehicle on a ground surface. Motion of a vehicle on a roadway can be described by a multi-dimensional state vector that includes vehicle location, orientation, speed, and acceleration. Specifically, the vehicle motion vector can include positions in x, y, z, yaw, pitch, roll, yaw rate, pitch rate, roll rate, heading velocity and heading acceleration that can be determined by fitting a polynomial function to successive 2D locations included in the vehicle motion vector with respect to the ground surface, for example. Further for example, the path polynomial p(x) is a model that predicts the path as a line traced by a polynomial equation. The path polynomial p(x) predicts the path for a predetermined upcoming distance x, by determining a lateral coordinate p, e.g., measured in meters:

$$p ( x ) = {a}_{0} + {a}_{1} x + {a}_{2} {x}^{2} + {a}_{3} {x}^{3} \qquad ( 8 )$$

where a₀ an offset, e.g., a lateral distance between the path and a center line of the vehicle 110 at the upcoming distance x, a₁ is a heading angle of the path, a₂ is the curvature of the path, and a₃ is the curvature rate of the path.

The path polynomial function can be used to direct the vehicle 110 from a current location to another location in an environment around the vehicle while maintaining minimum and maximum limits on lateral and longitudinal accelerations. The vehicle 110 can be operated along a vehicle path by transmitting commands to subsystems 112, 113, 114 to control vehicle propulsion, steering and brakes. Following block 510 process 500 ends.

Computing devices such as those described herein generally each includes commands executable by one or more computing devices such as those identified above, and for carrying out blocks or steps of processes described above. For example, process blocks described above may be embodied as computer-executable commands.

Computer-executable commands may be compiled or interpreted from computer programs created using a variety of programming languages and/or technologies, including, without limitation, and either alone or in combination, Java™, C, C++, Python, Julia, SCALA, Visual Basic, Java Script, Perl, HTML, etc. In general, a processor (e.g., a microprocessor) receives commands, e.g., from a memory, a computer-readable medium, etc., and executes these commands, thereby performing one or more processes, including one or more of the processes described herein. Such commands and other data may be stored in files and transmitted using a variety of computer-readable media. A file in a computing device is generally a collection of data stored on a computer readable medium, such as a storage medium, a random-access memory, etc.

A computer-readable medium (also referred to as a processor-readable medium) includes any non-transitory (i.e., tangible) medium that participates in providing data (e.g., instructions) that may be read by a computer (e.g., by a processor of a computer). Such a medium may take many forms, including, but not limited to, non-volatile media and volatile media. Instructions may be transmitted by one or more transmission media, including fiber optics, wires, wireless communication, including the internals that comprise a system bus coupled to a processor of a computer. Common forms of computer-readable media include, for example, RAM, a PROM, an EPROM, a FLASH-EEPROM, any other memory chip or cartridge, or any other medium from which a computer can read.

All terms used in the claims are intended to be given their plain and ordinary meanings as understood by those skilled in the art unless an explicit indication to the contrary is made herein. In particular, use of the singular articles such as “a,” “the,” “said,” etc. should be read to recite one or more of the indicated elements unless a claim recites an explicit limitation to the contrary.

The term “exemplary” is used herein in the sense of signifying an example, e.g., a candidate to an “exemplary widget” should be read as simply referring to an example of a widget.

The adverb “approximately” modifying a value or result means that a shape, structure, measurement, value, determination, calculation, etc. may deviate from an exactly described geometry, distance, measurement, value, determination, calculation, etc., because of imperfections in materials, machining, manufacturing, sensor measurements, computations, processing time, communications time, etc.

In the drawings, the same candidate numbers indicate the same elements. Further, some or all of these elements could be changed. With regard to the media, processes, systems, methods, etc. described herein, it should be understood that, although the steps or blocks of such processes, etc. have been described as occurring according to a certain ordered sequence, such processes could be practiced with the described steps performed in an order other than the order described herein. It should be understood that certain steps could be performed simultaneously, that other steps could be added, or that certain steps described herein could be omitted. In other words, the descriptions of processes herein are provided for the purpose of illustrating certain embodiments and should in no way be construed so as to limit the claimed invention. Any use of “based on” and “in response to” herein, including with reference to media, processes, systems, methods, etc. described herein, indicates a causal relationship, not merely a temporal relationship.

What is claimed is:

1. A system, comprising:
a computer that includes a processor and a memory, the memory including instructions executable by the processor to:
receive Global Navigation Satellite System (GNSS) error predictions corresponding to respective potential paths between a vehicle location and a specified destination;
identify a lowest-cost path from the potential paths based on path costs determined based on the respective GNSS error predictions for the potential paths; and
control a propulsion subsystem and/or a steering subsystem of the vehicle to operate the vehicle along the lowest-cost path.

2. The system of claim 1, wherein instructions to calculate the path costs include instructions to:
calculate an operating domain cost, a functionality cost, and a margin cost; and
sum at least the calculated operating domain cost, the calculated functionality cost, and the calculated margin cost.

3. The system of claim 2, wherein the instructions to calculate the operating domain cost include instructions to:
divide the potential path into multiple segments;
multiply the distance of each segment by a domain weight and a GNSS error prediction corresponding to the segment to determine an operating weighted distance; and
sum the operating weighted distances of the multiple segments.

4. The system of claim 2, wherein the instructions to calculate the functionality cost includes instructions to:
divide the potential path into multiple segments;
determine for each segment which of multiple predetermined ranges the GNSS error prediction corresponding to the segment is located;
multiply the distance of each segment by a weighting factor corresponding to the determined range to calculate a functionality weighted distance; and
sum the functionality weighted distances of the multiple segments.

5. The system of claim 2, wherein the instructions to calculate the margin cost includes instructions to:
divide the potential path into multiple segments;
multiply the distance of each segment by a margin factor calculated based on a GNSS error prediction corresponding to the segment to determine a margin weighted distance; and
sum the margin weighted distances of the multiple segments.

6. The system of claim 5, wherein the instructions to calculate the margin factor includes instructions to:
calculate a probability that a GNSS error distance will exceed a selected distance threshold based on the GNSS error prediction;
divide the probability by a desired probability to determine a probability weight; and
exponentiate the probability weight to a selected power.

7. The system of claim 6, wherein the instructions to calculate the probability include instructions to integrate a normal distribution function using the GNSS error prediction as a standard deviation.

8. The system of claim 2, wherein the instructions to calculate the functionality cost and the margin cost includes instructions to:
divide the potential path into multiple segments;
determine for each segment which of multiple predetermined ranges the GNSS error prediction corresponding to the segment is located;
multiply the distance of each segment by a weighting factor corresponding to the determined range to determine a functionality weighted distance;
multiply the distance of each segment by a margin factor calculated based on a GNSS error prediction corresponding to the segment to determine a margin weighted distance; and
sum the functionality weighted distances and the margin weighted distances of the multiple segments.

9. The system of claim 1, wherein the instructions to calculate the path costs include instructions to calculate the cost based on at least a potential path distance and a vehicle speed.

10. The system of claim 1, wherein the instructions further comprise instructions to determine the GNSS error predictions based on historical data for particular locations and times.

11. A method for vehicle navigation path planning, comprising:
receiving GNSS error predictions corresponding to respective potential paths between a vehicle location and a specified destination;
identifying a lowest-cost path from the potential paths based on path costs determined based on the respective GNSS error predictions for the potential paths; and
controlling a propulsion subsystem and/or a steering subsystem of the vehicle to operate the vehicle along the lowest-cost path.

12. The method of claim 11, wherein calculating the path costs includes:
calculating an operating domain cost, a functionality cost, and a margin cost; and
summing at least the calculated operating domain cost, the calculated functionality cost, and the calculated margin cost.

13. The method of claim 12, wherein calculating the operating domain cost includes:
dividing the potential path into multiple segments;
multiplying the distance of each segment by a domain weight and a GNSS error prediction corresponding to the segment to determine an operating weighted distance; and
summing the operating weighted distances of the multiple segments.

14. The method of claim 12, wherein calculating the functionality cost includes:
dividing the potential path into multiple segments;
determining for each segment which of multiple predetermined ranges the GNSS error prediction corresponding to the segment is located;
multiplying the distance of each segment by a weighting factor corresponding to the determined range to calculate a functionality weighted distance; and
summing the functionality weighted distances of the multiple segments.

15. The method of claim 12, wherein calculating the margin cost includes:
dividing the potential path into multiple segments;
multiplying the distance of each segment by a margin factor calculated based on a GNSS error prediction corresponding to the segment to determine a margin weighted distance; and
summing the margin weighted distances of the multiple segments.

16. The method of claim 15, wherein calculating the margin factor includes:
calculating a probability that a GNSS error distance will exceed a selected distance threshold based on the GNSS error prediction;
dividing the probability by a desired probability to determine a probability weight; and
exponentiating the probability weight to a selected power.

17. The method of claim 16, wherein calculating the probability includes integrating a normal distribution function using the GNSS error prediction as a standard deviation.

18. The method of claim 13, wherein calculating the functionality cost and the margin cost includes:
dividing the potential path into multiple segments;
determining for each segment which of multiple predetermined ranges the GNSS error prediction corresponding to the segment is located;
multiplying the distance of each segment by a weighting factor corresponding to the determined range to determine a functionality weighted distance;
multiplying the distance of each segment by a margin factor calculated based on a GNSS error prediction corresponding to the segment to determine a margin weighted distance; and
summing the functionality weighted distances and the margin weighted distances of the multiple segments.

19. The method of claim 11, wherein calculating the path costs includes calculating the cost based on at least a potential path distance and a vehicle speed.

20. The method of claim 11, further comprising determining the GNSS error predictions based on historical data for particular locations and times.
